(19) United States
(12) Patent Application Publication
(10) Pub. No.: US 2005/0090677 A1
(43) Pub. Date: Apr. 28, 2005

(54) Phosphinites

(75) Inventors: Michael Bartsch, Neustadt (DE); Robert Baumann, Mannheim (DE); Dagmar Pascale Kunsmann-Keitel, Limburgerhof (DE); Gerd Haderlein, Darmstadt (DE); Tim Jungkamp, Dossenheim (DE); Marco Altmayer, Mannheim (DE); Wolfgang Siegel, Limburgerhof (DE); Ferenc Molnar, Speyer (DE)

Correspondence Address: KEIL & WEINKAUF, 1350 CONNECTICUT AVENUE, N.W., WASHINGTON, DC, 20036, US

(73) Assignee: BASF Aktiengesellschaft, Ludwigshafen (DE)

(21) Appl. No.: 10/491,911

(22) PCT Filed: Oct. 4, 2002
(86) PCT No.: PCT/EP02/11108

(30) Foreign Application Priority Data
Oct. 12, 2001 (DE) 101 50 286.9

(51) Int. Cl. C07F 9/02

(52) U.S. Cl. 556/19; 558/162

(57) ABSTRACT

Phosphinites I of the formula 1, 2 or 3 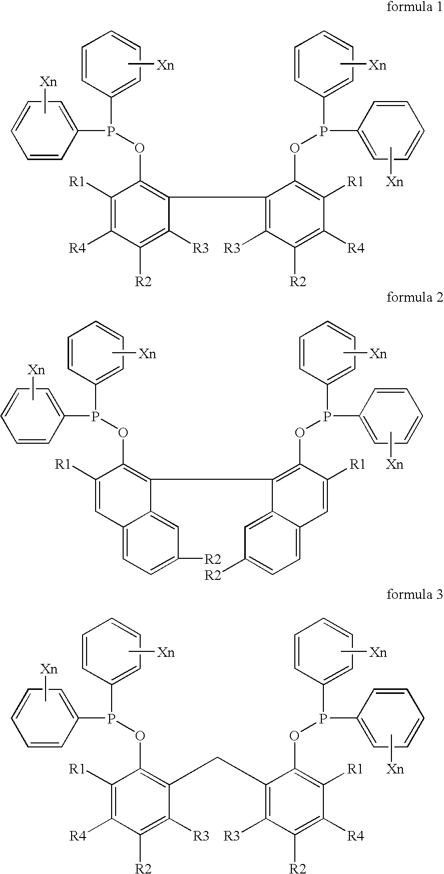 where R1, R2, R4 are each, independently of one another, hydrogen, an alkyl or alkylene group having from 1 to 8 carbon atoms or an alkoxy group having from 1 to 8 carbon atoms, with the proviso that at least one of the groups R1, R2, R4 is not H, R3 is H or methyl
X is F, Cl or CF₃ n is 0, 1 or 2 can be used as catalysts.

The present invention relates to novel phosphinites, in particular chelating phosphinites, methods of preparing them, their use as ligands in transition metal complexes, novel transition metal complexes, a process for preparing the complexes, their use as catalyst and processes carried out in the presence of such transition metal complexes as catalysts.

Chelating phosphinites, nickel complexes containing such phosphinites as ligands and the use of such complexes as catalysts are known.

U.S. Pat. Nos. 5,693,843 and 5,523,453 describe a process for the hydrocyanation of unsaturated organic compounds and the isomerization of nitriles in the presence of nickel(0) complexes containing chelating phosphinites as ligands.

It would be desirable to improve the stability of the chelating phosphinite ligands to increase the operating life of the catalyst. Furthermore, an improvement in the selectivity of the catalyst, for example to 3-pentenenitrile in the hydrocyanation of butadiene or to adiponitrile in the hydrocyanation of 3-pentenenitrile, and an improvement in the space-time yield are desirable.

It is an object of the present invention to provide phosphinites which are suitable as chelating phosphinites and display high stability, high reactivity and high selectivity when used as catalysts in the hydrocyanation of unsaturated organic compounds.

We have found that this object is achieved by phosphinites I of the formula 1, 2 or 3 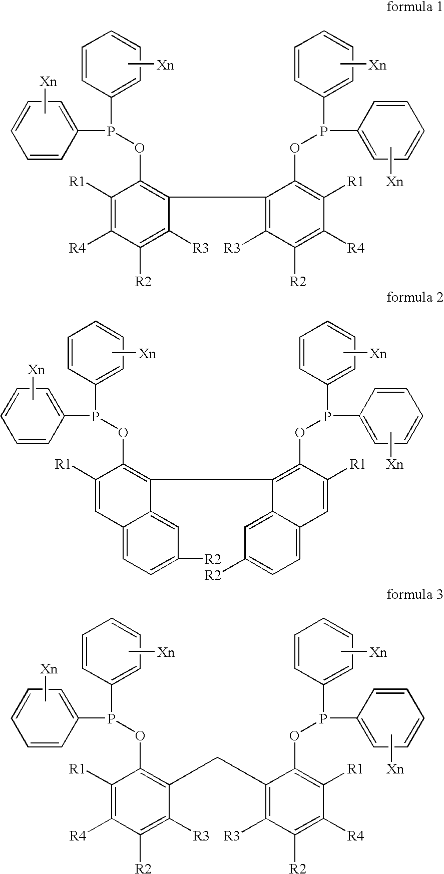
where
R1, R2, R4 are each, independently of one another, hydrogen, an alkyl or alkylene group having from 1 to 8 carbon atoms or an alkoxy group having from 1 to 8 carbon atoms, with the proviso that at least one of the groups R1, R2, R4 is not H,
R3 is H or methyl
X is F, C₁ or CF₃
n is 0, 1 or 2
and mixtures thereof.

The present invention also provides methods of preparing them, provides for their use as ligands in transition metal complexes, provides novel transition metal complexes and processes for preparing them, provides for their use as catalyst and provides processes carried out in the presence of such transition metal complexes as catalyst.

According to the present invention, the radicals R1, R2, R4 are each, independently of one another, hydrogen, an alkyl or alkylene group having from 1 to 8 carbon atoms or an alkoxy group having from 1 to 8 carbon atoms, with the proviso that at least one of the groups R1, R2, R4 is not H.

If R1 is hydrogen, then it is possible for R2 to be hydrogen and R4 to be an alkyl or alkylene group having from 1 to 8 carbon atoms or an alkoxy group having from 1 to 8 carbon atoms or R2 to be an alkyl or alkylene group having from 1 to 8 carbon atoms or an alkoxy group having from 1 to 8 carbon atoms and R4 to be hydrogen or R2 and R4 each to be, independently of one another, an alkyl or alkylene group having from 1 to 8 carbon atoms or an alkoxy group having from 1 to 8 carbon atoms.

If R1 is an alkyl or alkylene group having from 1 to 8 carbon atoms or an alkoxy group having from 1 to 8 carbon atoms, then it is possible for R2 and R4 to be hydrogen or R2 to be, independently of R1, an alkyl or alkylene group having from 1 to 8 carbon atoms or an alkoxy group having from 1 to 8 carbon atoms and R4 to be hydrogen or R2 to be hydrogen and R4 to be, independently of R1, an alkyl or alkylene group having from 1 to 8 carbon atoms or an alkoxy group having from 1 to 8 carbon atoms or R2 and R4 each to be, independently of one another and independently of R1, an alkyl or alkylene group having from 1 to 8 carbon atoms or an alkoxy groupo having from 1 to 8 carbon atoms.

As alkyl or alkylene group having from 1 to 8 carbon atoms, preference is given to an alkyl group having from 1 to 8 carbon atoms, in particular from 1 to 4 carbon atoms, advantageously selected from the group consisting of methyl, ethyl, n-propyl, i-propyl, n-butyl, s-butyl, i-butyl and t-butyl, in particular from the group consisting of methyl, ethyl, n-propyl, i-propyl and t-butyl.

As alkoxy group having from 1 to 8 carbon atoms, preference is given to an alkoxy group having from 1 to 4 carbon atoms, advantageously selected from the group consisting of methoxy, ethoxy, n-propoxy, i-propoxy, n-butoxy, s-butoxy, i-butoxy and t-butoxy, in particular methoxy.

According to the present invention, R3 is H or a methyl group.

According to the present invention, the phenyl groups bound to a phosphorus atom may be unsubstituted or bear, independently of one another, 1 or 2 substituents X per phenyl group, so that n is 0, 1 or 2.

The two phenyl groups bound to a phosphorus atom can have identical or different substitution patterns; in the case of different substitution patterns, the differences may be both in the number of substituents and in the type of substituents. For the purposes of the present invention, the phenyl groups bound to a phosphorus atom in the formulae 1, 2 and 3 may in each case have identical or different substitution patterns.

According to the present invention, X is F, C₁ or CF₃, preferably F or CF₃.

In the case of n being 2, the two radicals X1 and X2 can be F, Cl or CF₃ independently of one another, i.e. F and F, F and Cl, F and CF₃, Cl and C₁, C₁ and CF₃, CF₃ and CF₃, preferably F and F, CF₃ and CF₃.

In a preferred embodiment, when n is 1 and X is F, the substituent is present in the m position relative to the phosphorus atom bound to the phenyl ring in a phenyl ring bound to a phosphorus atom.

In a further, preferred embodiment, when n is 1 and X is CF₃, the substituent is present in the p position relative to the phosphorus atom bound to the phenyl ring in a phenyl ring bound to a phosphorus atom.

In a preferred embodiment, when n is 2 and X1 and X2 are each F, the substituents are present in the two m positions relative to the phosphorus atom bound to the phenyl ring in a phenyl ring bound to a phosphorus atom.

In a further, preferred embodiment, when n is 2 and X are each CF₃, the substituents are present in the two m positions relative to the phosphorus atom bound to the phenyl ring in a phenyl ring bound to a phosphorus atom.

Particularly preferred phosphinites have the formulae Ia-Ij below, where the groups R1, R2, R3 and R4 have the meanings listed in Table 1.

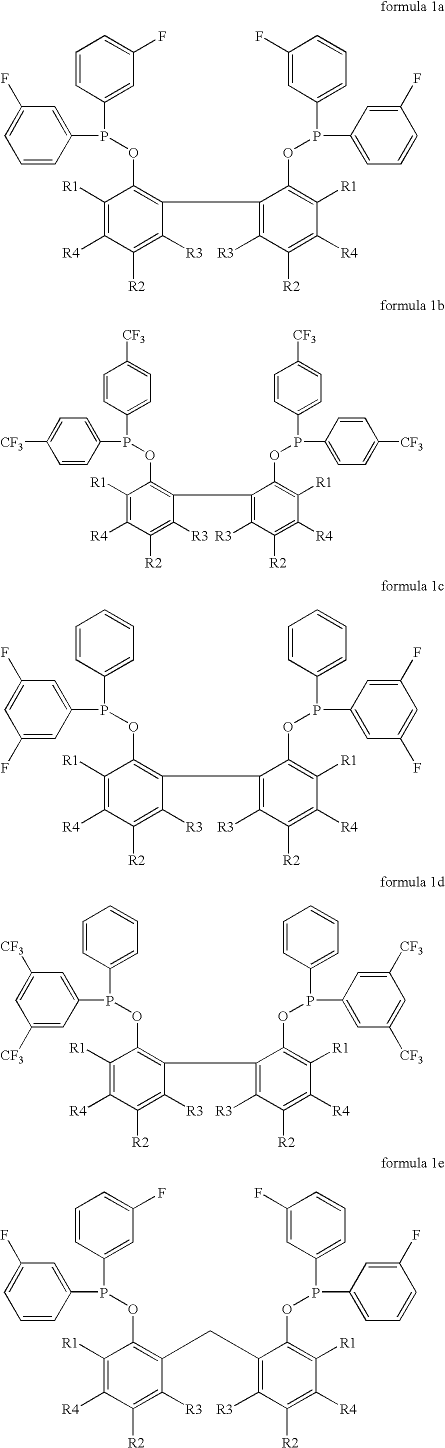

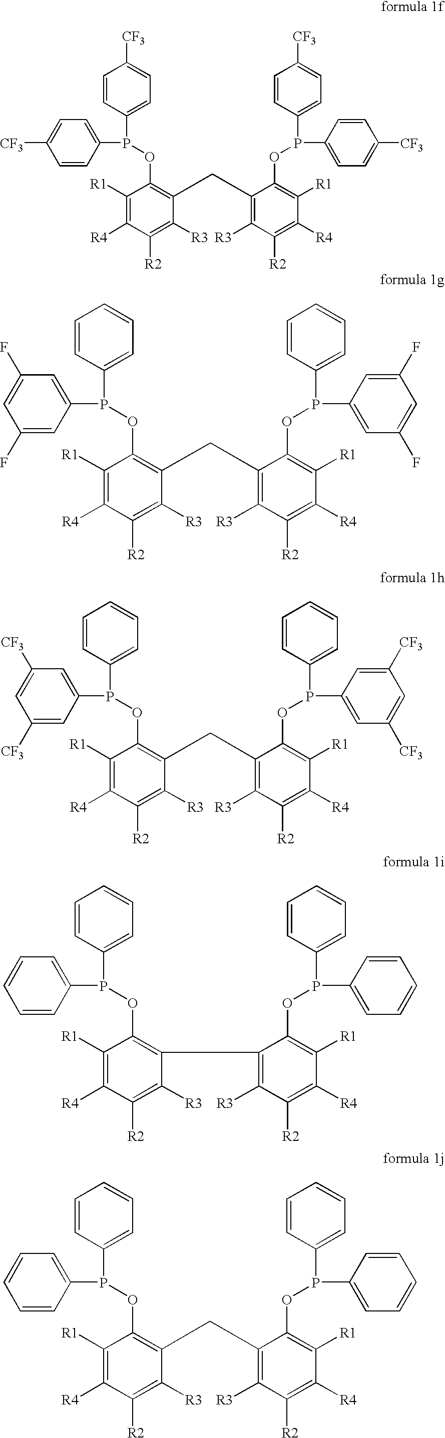

In these formulae, the radicals R1, R2, R3 and R4 have the following meanings:

TABLE 1

| Formula | R1 | R2 | R3 | R4 |
|---|---|---|---|---|
| Ia1, Ib1, Ic1, Id1, Ie1, If1, Ig1, | Me | Me | H | H |
| Ih1, Ii1, Ij1 | | | | |
| Ia2, Ib2, Ic2, Id2, Ie2, If2, Ig2, | Et | Et | H | H |
| Ih2, Ii2, Ij2 | | | | |
| Ia3, Ib3, Ic3, Id3, Ie3, If3, Ig3, | n-Pr | n-Pr | H | H |
| Ih3, Ii3, Ij3 | | | | |
| Ia4, Ib4, Ic4, Id4, Ie4, If4, Ig4, | t-Bu | t-Bu | H | H |
| Ih4, Ii4, Ij4 | | | | |
| Ia5, Ib5, Ic5, Id5, Ie5, If5, Ig5, | Et | Me | H | H |
| Ih5, Ii5, Ij5 | | | | |
| Ia6, Ib6, Ic6, Id6, Ie6, If6, Ig6, | n-Pr | Me | H | H |
| Ih6, Ii6, Ij6 | | | | |
| Ia7, Ib7, Ic7, Id7, Ie7, If7, Ig7, | t-Bu | Me | H | H |
| Ih7, Ii7, Ij7 | | | | |
| Ia8, Ib8, Ic8, Id8, Ie8, If8, Ig8, | Me | Me | H | Me |
| Ih8, Ii8, Ij8 | | | | |
| Ia9, Ib9, Ic9, Id9, Ie9, If9, Ig9, | t-Bu | Me | Me | H |
| Ih9, Ii9, Ij9 | | | | |

Further particularly preferred phosphinites have the formulae Ik-Io, where the groups R1 and R2 have the meanings listed in Table 2.

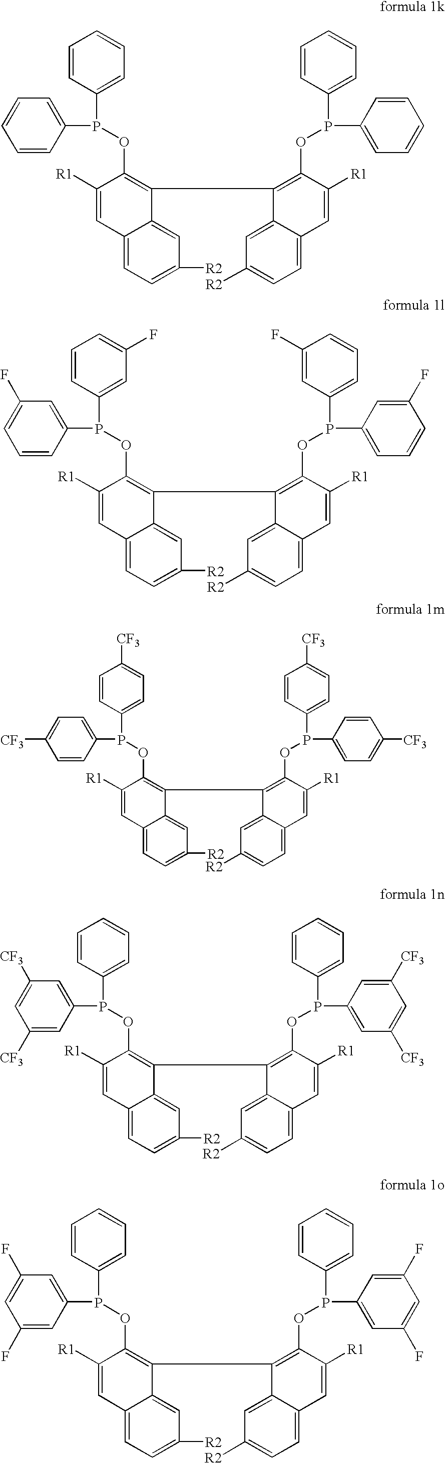

In these formulae, the radicals R1 and R2 have the following meanings:

TABLE 2

| Formula | R1 | R2 |
|---|---|---|
| Ik1, Il1, Im1, In1, Io1 | Me | H |
| Ik1, Il1, Im1, In1, Io1 | Me | OMe |

In Tables 1 and 2, the abbreviations have the following meanings:
H: hydrogen
Me: methyl
Et: ethyl
n-Pr: n-propyl
t-Bu: t-butyl
OMe: methoxy

Phospinite I can be prepared by methods based on those described in U.S. Pat. Nos. 5,523,453 and 5,693,843 for the phosphinite ligands described there, for example by reacting a substituted or unsubstituted (Xn-phenyl)(Xn-phenyl)phosphine chloride with a diol bearing the groups R1, R2, R3 and R4.

The preparation proceeds efficiently and economically from readily available starting materials.

The diphenylphosphine chlorides used as starting compounds and their preparation are known per se, for example from: H. Schindlbauer, Monatshefte Chemie, volume 96, 1965, pages 1936-1942. The process described there for preparing 4-fluorophenyldichlorophosphine can be employed analogously for preparing the (Xn-phenyl)(Xn-phenyl)phosphine chlorides. The optimum parameters for preparing the respective (Xn-phenyl)(Xn-phenyl)phosphine chlorides can readily be determined by a few simple preliminary experiments.

The phosphinites I can be used as ligands in transition metal complexes.

Transition metals which can advantageously be used are the metals of transition groups I, II and VI to VIII of the Periodic Table, preferably transition group VIII of the Period Table, particularly preferably iron, cobalt and nickel, in particular nickel.

If nickel is used, it can be present in various oxidation states such as 0, +1, +2, +3. Preference is given to nickel(0) and nickel(+2), in particular nickel(0).

To prepare the transition metal complexes, a chemical compound of a transition metal or preferably a transition metal can be reacted with a phosphinite I, with the phosphinite I used being able to be either a single phosphinite I or a mixture of a plurality of phosphinites I.

Prior to the reaction, the transition metal can be obtained from suitable chemical compounds, e.g. salts such as chlorides, for example by reduction with base metals such as zinc.

If a transition metal compound is used for preparing the transition metal complexes, advantageous compounds are salts such as chlorides, bromides, acetylacetonates, sulfates, nitrates, for example nickel(2) chloride, or Ni(0) complexes such as bis(1,5-cyclooctadiene)Ni(0).

After the reaction of the transition metal compound or the transition metal with a phosphinite I, the oxidation state of the transition metal in the complex can be altered by means of suitable oxidizing or reducing agents, for example base metals such as zinc or hydrogen in chemically bound form, e.g. sodium borohydride, or in molecular form, or electrochemically.

In a particularly preferred embodiment, a complex of Ni(0) with organic monophosphine, monophosphinite, monophosphonite or monophosphite ligands can be reacted with a phosphinite I using a method based on that described in the German patent application 10136488.1.

In the transition metal complexes, the molar ratio of transition metal to phosphinite I can be in the range from 1 to 6, preferably from 2 to 5, in particular 2, 3 or 4.

The transition metal complexes can be free of ligands other than the phosphinites I.

The transition metal complexes may further comprise other ligands in addition to the phosphinites I, for example nitriles such as acetonitrile, adiponitrile, 3-pentenenitrile, 4-pentenenitrile, 2-methyl-3-butenenitrile, olefins such as butadiene or phosphorus compounds such as organic monophosphines, monophosphinites, monophosphonites or monophosphites.

The preparation of such transition metal complexes can be carried out by methods analogous to those described in the literature, for example in DE-A-2 237 703, U.S. Pat. No. 3,850,973, U.S. Pat. No. 3,766,237 or U.S. Pat. No. 3,903,120, for preparing transition metal complexes containing tri-o-tolyl phosphite, tri-m-tolyl phosphite or tri-p-tolyl phosphite ligands by replacing these phosphites partly or completely by the phosphinites I of the present invention.

The transition metal complexes of the present invention can be used as catalysts, in particular as homogeneous catalysts.

It has been found to be particularly advantageous to use the transition metal complexes of the present invention as catalysts in the addition of hydrocyanic acid onto olefinic double bonds, in particular double bonds which are conjugated with a further olefinic double bond, for example onto a double bond of butadiene to give a mixture comprising 2-methyl-3-butenenitrile and 3-pentenenitrile. It is equally advantageous to use the transition metal complexes of the invention as catalysts in the addition of hydrocyanic acid onto olefinic double bond which are not conjugated with a further olefinic double bond, for example onto the double bond of 3-pentenenitrile or 4-pentenenitrile or mixtures thereof, preferably 3-pentenenitrile, to give adiponitrile, or onto 3-pentenoic esters or 4-pentenoic esters or mixtures thereof, preferably 3-pentenoic esters, to give 5-cyanovaleric esters.

It has likewise been found to be particularly advantageous to use the transition metal complexes of the present invention as catalysts in the isomerization of organic nitriles, in particular ones in which the nitrile group is not conjugated with an olefinic double bond, for example the isomerization of 2-methyl-3-butenenitrile to give 3-pentenenitrile. It is equally advantageous to use the transition metal complexes of the present invention as catalysts in the isomerization of organic nitrites in which the nitrile group is conjugated with an olefinic double bond.

Processes for the addition of hydrocyanic acid onto an olefinic double bond or for the isomerization of organic nitrites can be carried out in a manner analogous to that described, for example, in WO 99/13983 or WO 99/64155, by partly or completely replacing the phosphonites described there by the phosphinites I of the present invention.

The invention also provides a process for preparing mixtures of monoolefinic C₅-mononitriles having nonconjugated C═C and C═N bonds by hydrocyanation of a 1,3-butadiene-containing hydrocarbon mixture in the presence of at least one of the above described systems according to the present invention as catalyst.

The preparation of monoolefinic C₅-mononitriles by the process of the present invention is preferably carried out using a hydrocarbon mixture having a 1,3-butadiene content of at least 10% by volume, preferably at least 25% by volume, in particular at least 40% by volume.

To prepare mixtures of monoolefinic C₅-mononitriles which comprise, for example, 3-pentenenitrile and 2-methyl-3-butenenitrile and are suitable as intermediates for further processing to produce adiponitrile, it is possible to use pure butadiene or 1,3-butadiene-containing hydrocarbon mixtures.

1,3-Butadiene-containing hydrocarbon mixtures are available on an industrial scale. Thus, for example, the processing of petroleum by steam cracking of naphtha produces a hydrocarbon mixture known as C₄ fraction which has a high total olefin content, with about 40% being 1,3-butadiene and the remainder being made up of monoolefins and multiply unsaturated hydrocarbons and also alkanes. These streams always contain small proportions of generally up to 5% of alkynes, 1,2-dienes and vinylacetylene.

Pure 1,3-butadiene can be isolated from industrially available hydrocarbon mixtures by, for example, extractive distillation.

C₄ fractions are, if desired, substantially freed of alkynes, e.g. propyne or butyne, of 1,2-dienes, e.g. propadiene, and of alkenynes, e.g. vinylacetylene. Otherwise, the products in which a C═C double bond is conjugated with the C═N bond are sometimes obtained. It is known from “Applied Homogeneous Catalysis with Organometalic Compounds”, vol. 1, VCH Weinheim, p. 479, that the conjugated 2-pentenenitrile formed in the isomerization of 2-methyl-3-butenenitrile and 3-pentenenitrile acts as a reaction inhibitor for the second addition of hydrogen cyanide to form adiponitrile. It has been found that the above-mentioned conjugated nitriles obtained in the hydrocyanation of an unpretreated C₄ fraction also act as catalyst poisons for the first reaction step of the preparation of adipic acid, namely the monoaddition of hydrogen cyanide.

For this reason, it may be useful to free the hydrocarbon mixture partly or completely of components which form catalyst poisons in the catalytic hydrocyanation, in particular alkynes, 1,2-dienes and mixtures thereof. To remove these components, the C₄ fraction is subjected to a catalytic partial hydrogenation before the addition of hydrogen cyanide. This partial hydrogenation is carried out in the presence of a hydrogenation catalyst which is capable of selectively hydrogenating alkynes and 1,2-dienes in the presence of other dienes and monoolefins.

Suitable heterogeneous catalyst systems generally comprise a transition metal compound on an inert support. Suitable inorganic supports are the customary oxides, in particular silicon and aluminum oxides, aluminosilicates, zeolites, carbides, nitrides, etc., and mixtures thereof. Preference is given to using Al₂O₃, SiO₂ and mixtures thereof as supports. In particular, the heterogeneous catalysts used are those described in U.S. Pat. No. 4,587,369; U.S. Pat. No. 4,704,492 and U.S. Pat. No. 4,493,906, which are hereby fully incorporated by reference. Further suitable catalyst systems based on Cu are marketed by Dow Chemical as KLP catalyst.

The addition reaction of hydrogen cyanide with 1,3-butadiene or a 1,3-butadiene-containing hydrocarbon mixture, e.g. a pretreated, partially hydrogenated C₄ fraction, can be carried out continuously, semicontinuously or batchwise.

In a useful variant of the process of the present invention, the addition reaction of the hydrogen cyanide is carried out continuously. Suitable reactors for a continuous reaction are known to those skilled in the art and are described, for example, in Ullmanns Enzyklopädie der technischen Chemie, vol. 1, 3rd edition, 1951, p. 743 ff. The continuous variant of the process of the present invention is preferably carried out using a cascade of stirred vessels or a tube reactor.

In a preferred variant of the process of the present invention, the addition reaction of hydrogen cyanide with 1,3-butadiene or a 1,3-butadiene-containing hydrocarbon mixture is carried out semicontinuously.

The semicontinuous process comprises
a) charging a reactor with the hydrocarbon mixture, if desired part of the hydrogen cyanide and a hydrocyanation catalyst according to the present invention, if desired produced in situ, and, if desired, a solvent,
b) reacting the mixture at elevated temperature and superatmospheric pressure, with hydrogen cyanide being fed in at the rate at which it is consumed,
c) completing the conversion by a period of after-reaction and subsequently working up the mixture.

Suitable pressure-rated reactors are known to those skilled in the art and are described, for example, in Ullmanns Enzyklopädie der technischen Chemie, vol. 1, 3rd edition, 1951, p. 769 ff. In general, the process of the present invention is carried out using an autoclave which may, if desired, be provided with a stirrer and an internal lining. For the above steps, the following procedures/conditions are preferred:

Step a):

The pressure-rated reactor is charged with the partially hydrogenated C₄ fraction or butadiene, hydrogen cyanide, a hydrocyanation catalyst and, if desired, a solvent prior to commencement of the reaction. Suitable solvents are those mentioned above for the preparation of the catalysts of the present invention, preferably aromatic hydrocarbons such as toluene and xylene, or tetrahydrofuran.

Schritt b):

The mixture is generally reacted at elevated temperature and superatmospheric pressure. The reaction temperature is generally in a range from about 0 to 200° C., preferably from about 50 to 150° C. The pressure is generally in a range from about 1 to 200 bar, preferably from about 1 to 100 bar, in particular from 1 to 50 bar, particularly preferably from 1 to 20 bar. During the reaction, hydrogen cyanide is fed in at a rate corresponding to that at which it is consumed, with the pressure in the autoclave remaining essentially constant. The reaction time is from about 30 minutes to 5 hours.

Step c):

To complete the conversion, the reaction time can be followed by an after-reaction time of up to about 5 hours, preferably from about 1 hour to 3.5 hours, during which no more hydrogen cyanide is fed into the autoclave. During this time, the temperature is kept essentially constant at the reaction temperature set during the addition of hydrogen cyanide. Work-up is carried out by customary methods and comprises separating off the unreacted 1,3-butadiene and the unreacted hydrogen cyanide, e.g. by washing or extraction, and fractionally distilling the remaining reaction mixture to separate off the product of value and recover the still active catalyst.

In a further useful variant of the process of the present invention, the addition reaction of the hydrogen cyanide with the 1,3-butadiene-containing hydrocarbon mixture is carried out batchwise. Here, essentially the same reaction conditions as described for the semicontinuous process are maintained, but no additional hydrogen cyanide is fed in step b). All of the hydrogen cyanide is included in the initial charge.

In general, the preparation of adiponitrile from a butadiene-containing mixture by addition of 2 molar equivalents of hydrogen cyanide can be divided into three steps:
1. Preparation of mixtures of C₅-monoolefins having a nitrile function.
2. Isomerization of the 2-methyl-3-butenenitrile present in these mixtures to form 3-pentenenitrile and isomerization of the 3-pentenenitrile formed in this way and the 3-pentenenitrile already present in the mixtures from step 1 to form various n-pentenenitriles. A very high proportion of 3-pentenenitrile or 4-pentenenitrile and a very small proportion of conjugated 2-pentenenitrile and 2-methyl-2-butenenitrile, which may act as catalyst poisons, should be formed.
3. Preparation of adiponitrile by addition of hydrogen cyanide onto the 4-pentenenitrile which has previously been formed in situ by isomerization of the 3-pentenenitrile formed in step 2. By-products formed are, for example, 2-methylglutaronitrile from the Markovnikov addition of hydrogen cyanide onto 4-pentenenitrile or the anti-Markovnikov addition of hydrogen cyanide onto 3-pentenenitrile and ethyl succinonitrile from the Markovnikov addition of hydrogen cyanide onto 3-pentenenitrile.

The novel catalysts based on phosphinite ligands can also be used advantageously for the structural isomerization and double bond isomerization in step 2 and/or the second addition of hydrogen cyanide in step 3.

Advantageously, the catalysts used according to the present invention not only display a high selectivity to the monoaddition products obtained in the hydrocyanation of 1,3-butadiene-containing hydrocarbon mixtures but they can also be admixed with an excess of hydrogen cyanide without appreciable deposition of inactive nickel(II) compounds, e.g. nickel(II) cyanide, occurring. In contrast to known hydrocyanation catalysts based on uncomplexed phosphine and phosphite ligands, the catalysts comprising a phosphonite I are thus suitable not only for continuous hydrocyanation processes in which an excess of hydrogen cyanide in the reaction mixture can generally be effectively avoided but also for semicontinuous processes and batch processes in which a large excess of hydrogen cyanide is generally present. The catalysts used according to the present invention and the hydrocyanation processes based on them generally display higher catalyst recycle rates and longer catalyst operating times than do known processes. Apart from the economic aspect, this is also a advantageous for ecological reasons since the nickel cyanide formed by reaction of the active catalyst with hydrogen cyanide is highly toxic and has to be worked up or disposed of at high costs.

Apart from the hydrocyanation of 1,3-butadiene-containing hydrocarbon mixtures, the systems of the present invention are generally suitable for all customary hydrocyanation processes. Particular mention may be made of the hydrocyanation of unactivated olefins, e.g. styrene and 3-pentenenitrile.

The addition of hydrocyanic acid onto an olefinic double bond in the presence of a catalyst system according to the present invention, in particular the addition onto butadiene or onto 3-pentenenitrile, 4-pentenenitrile or a mixture of such pentenenitriles or the isomerization of organic nitriles in the presence of a catalyst system according to the present invention, in particular the isomerization of 2-methyl-3-butenenitrile to 3-pentenenitrile, can advantageously be carried out in the presence of one or more Lewis acids as promoters which influence the activity, selectivity or both of the catalyst system of the present invention. Possible promoters are inorganic and organic compounds in which the cation is selected from the group consisting of scandium, titanium, vanadium, chromium, manganese, iron, cobalt, copper, zinc, boron, aluminum, yttrium, zirconium, niobium, molybdenum, cadmium, rhenium and tin. Examples which may be mentioned are ZnBr₂, ZnI₂, ZnCl₂, ZnSO₄, CuCl₂, CuCl, Cu(O₃SCF₃)₂, CoCl₂, CoI₂, FeI₂, FeCl₃, FeCl₂, FeCl₂(THF)₂, TiCl₄(THF)₂, TiCl₄, TiCl₃, ClTi(O-iso-Pr)₃, MnCl₂, ScCl₃, AlCl₃, (C₈H₁₇)AlCl₂, (C₈H₁₇)₂AlCl, (iso-C₄H₉)₂AlCl, Ph₂AlCl, PhAlCl₂, ReCl₅, ZrCl₄, ZrCl₂, NbCl₅, VCl₃, CrCl₂, MoCl₅, YCl₃, CdCl₂, LaCl₃, Er(O₃SCF₃)₃, Yb(O₂CCF₃)₃, SmCl₃, B(C₆H₅)₃, TaCl₅, as are generally described, for example in U.S. Pat. No. 6,171,996 B1. Further suitable promoters are described in the patents U.S. Pat. No. 3,496,217, U.S. Pat. No. 3,496,218 and U.S. Pat. No. 4,774,353. These comprise metal salts such as ZnCl₂, CoI₂ and SnCl₂, and organometallic compounds such as RAlCl₂, R₃SnO₃SCF₃ and R₃B, where R is an alkyl group or aryl groups. U.S. Pat. No. 4,874,884 describes the selection of synergistically effective combinations of promoters to increase the catalystic activity of the catalyst system. Preferred promoters include CdCl₂, FeCl₂, ZnCl₂, B(C₆H₅)₃ and (C₆H₅)₃SnZ, where Z is CF₃SO₃, CH₃C₆H₄SO₃ or(C₆H₅)₃BCN.

The molar ratio of promoter to nickel in the catalyst system can be in the range from 1:16 to 50:1.

A further advantageous embodiment of hydrocyanation and isomerization may be found in U.S. Pat. No. 5,981,772, whose contents are hereby incorporated by reference, with the proviso that a catalyst system according to the present invention or a mixture of such catalyst systems is used in place of the catalyts mentioned in the patent cited.

A further advantageous embodiment of hydrocyanation and isomerization may be found in U.S. Pat. No. 6,127,567, whose contents are hereby incorporated by reference, with the proviso that a catalyst system according to the present invention or a mixture of such catalyst systems is used in place of the catalyts mentioned in the patent cited.

A further advantageous embodiment of hydrocyanation may be found in U.S. Pat. No. 5,693,843, whose contents are hereby incorporated by reference, with the proviso that a catalyst system according to the present invention or a mixture of such catalyst systems is used in place of the catalyts mentioned in the patent cited.

A further advantageous embodiment of hydrocyanation may be found in U.S. Pat. No. 5,523,453, whose contents are hereby incorporated by reference, with the proviso that a catalyst system according to the present invention or a mixture of such catalyst systems is used in place of the catalyts mentioned in the patent cited.

The invention is illustrated by the following nonlimiting examples.

### EXAMPLES

The yields were determined by gas chromatography (column: 30 m Stabil-Wachs, temperature program: 5 minutes isothermal at 50° C., then heating at a rate of 5° C./min to 240° C., gas chromatograph: Hewlett Packard HP 5890).

All examples were carried out under a protective argon atmosphere.

The abbreviation nickel(0)-(m/p-tolyl phosphite) is used for a mixture comprising 2.35% by weight of Ni(0), 19% by weight of 3-pentenenitrile and 78.65% by weight of m/p-tolyl phosphite having an m/p ratio of 2:1.

Chelating ligands used were: 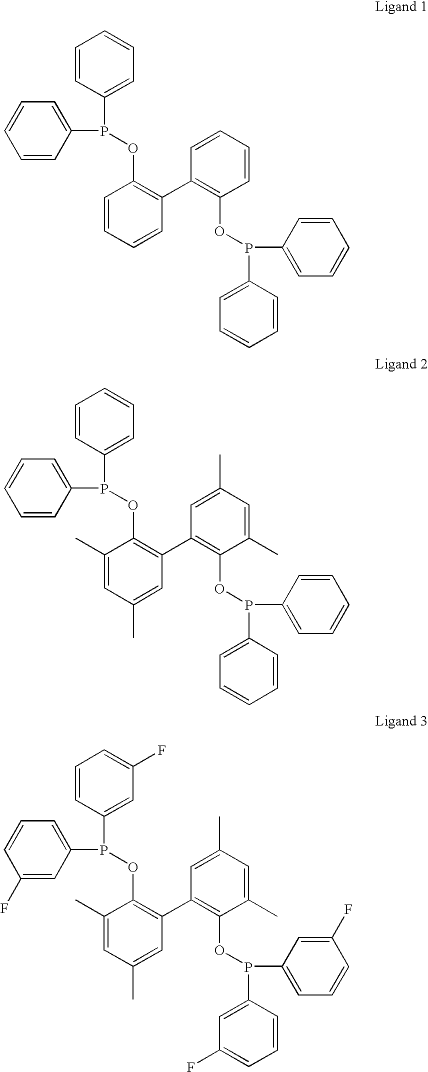
Ni(COD)₂ for bis(1,4-cyclooctadiene)Ni(O), 2M3BN for 2-methyl-3-butenenitrile, t2M2BN for trans-2-methyl-2-butenenitrile, c2M2BN for cis-2-methyl-2-butenenitrile, t2PN for trans-2-pentenenitrile, 4PN for 4-pentenenitrile, t3PN for trans-3-pentenenitrile, c3PN for cis-3-pentenenitrile, MGN for methylglutaronitrile, 3PN for the sum of t3PN and c3PN, BD for 1,3-butadiene, HCN for hydrocyanic acid, ADN for adiponitrile and THF for tetrahydrofuran.

### Examples 1-5

### Hydrocyanation of Butadiene to form 3-pentenenitrile

### Example 1 (Comparison)

### (1 mmol of Ni(0))

1 equivalent of Ni(COD)₂ was stirred with 3 equivalents of ligand 1 in THF for 20 minutes. This solution was admixed with 480 equivalents of BD and 400 equivalents of HCN in THF, placed in a glass autoclave at 25° C. and heated to 80° C. The temperature during the reaction (slightly exothermic reaction) was determined by means of an internal thermometer and after 180 minutes the conversion of HCN into 2M3BN and 3PN was determined by gas chromatography (GC percent by weight, internal standard: ethylbenzene). The following results were obtained:

| | Internal |
|---|---|
| Time | temperature |
| 5 Min | 85 |
| 10 min | 89 |
| 15 min | 92.5 |
| 20 min | 90.3 |
| 30 min | 86.1 |
| 60 min | 82 |
| 120 min | 81 |

The conversion of HCN into 2M3BN/3PN was 88.0%. The ratio of 2M3BN/3PN was 3/1.

### Example 2 (Comparison)

### (1 mmol of Ni(0))

1 equivalent of nickel(0)-(m/p-tolyl phosphite) was stirred with 1.2 equivalents of ligand 1 in THF for 12 hours. This solution was admixed with 462 equivalents of BD and 390 equivalents of HCN in THF, placed in a glass autoclave at 25° C. and heated to 80° C. The temperature during the reaction (slightly exothermic reaction) was determined by means of an internal thermometer and after 180 minutes the conversion of HCN into 2M3BN and 3PN was determined by gas chromatography (GC percent by weight, internal standard: ethylbenzene). The following results were obtained:

| | Internal |
|---|---|
| Time | temperature |
| 30 min | 91 |
| 40 min | 122 |
| 50 min | 84 |
| 60 min | 80.2 |
| 120 min | 80.2 |

The conversion of HCN into 2M3BN/3PN was over 99%. The ratio of 2M3BN/3PN was 2.5/1.

### Example 3 (According to the Present Invention)

### (1 mmol of Ni(0))

1 equivalent of Ni(COD)₂ was stirred with 3 equivalents of ligand 2 in THF for 20 minutes. This solution was admixed with 480 equivalents of BD and 400 equivalents of HCN in THF, placed in a glass autoclave at 25° C. and heated to 80° C. The temperature during the reaction (slightly exothermic reaction) was determined by means of an internal thermometer and after 180 minutes the conversion of HCN into 2M3BN and 3PN was determined by gas chromatography (GC percent by weight, internal standard: ethylbenzene). The following results were obtained:

| | Internal |
|---|---|
| Time | temperature |
| 2 min | 87 |
| 4 min | 101 |
| 5 min | 120 |
| 6 min | 141 |
| 10 min | 101 |
| 20 min | 83 |
| 60 min | 80 |
| 120 min | 80 |

The conversion of HCN into 2M3BN/3PN was 98%. The ratio of 2M3BN/3PN was 2/1.

### Example 4 (According to the Present Invention)

### (0.52 mmol of Ni(0))

1 equivalent of nickel(0)-(m/p-tolyl phosphite) was stirred with 1.2 equivalents of ligand 2 in THF for 12 hours. This solution was admixed with 534 equivalents of BD and 432 equivalents of HCN in THF, placed in a glass autoclave at 25° C. and heated to 80° C. The temperature during the reaction (slightly exothermic reaction) was determined by means of an internal thermometer and after 180 minutes the conversion of HCN into 2M3BN and 3PN was determined by gas chromatography (GC percent by weight, internal standard: ethylbenzene). The following results were obtained:

| | Internal |
|---|---|
| Time | temperature |
| 5 min | 91 |
| 8 min | 130 |
| 15 min | 89 |
| 30 min | 81 |
| 120 min | 80 |

The conversion of HCN into 2M3BN/3PN was 92%. The ratio of 2M3BN/3PN was 2.7/1.

### Example 5 (Comparison)

### (1 mmol of Ni(0))

1 equivalent of nickel(0)-(m/p-tolyl phosphite) was was admixed with 560 equivalents of BD and 420 equivalents of HCN in THF, placed in a glass autoclave at 25° C. and heated to 80° C. The temperature during the reaction (slightly exothermic reaction) was determined by means of an internal thermometer and after 180 minutes the conversion of HCN into 2M3BN and 3PN was determined by gas chromatography (GC percent by weight, internal standard: ethylbenzene). The following results were obtained:

| | Internal |
|---|---|
| Time | temperature |
| 30 min | 80.3 |
| 50 min | 80.5 |
| 60 min | 80.4 |
| 180 min | 80.3 |

The conversion of HCN into 2M3BN/3PN was 9.8%. The ratio of 2M3BN/3PN was 1/3.4.

### Example 6-8

### Isomerization of 2-methyl-3-butenenitrile to 3-pentenenitrile

### Example 6 (Comparison)

### (0.5 mmol of Ni(0))

1 equivalent of nickel(0)-(m-/p-tolyl phosphite) was admixed with 465 equivalents of 2M3BN and heated to 115° C. Samples were taken from the reaction mixture after 90 minutes and after 180 minutes and analyzed by gas chromatography (GC % by area). The following results were obtained:

| | | | | | | | | |
|---|---|---|---|---|---|---|---|---|
| Time | 2M3BN | t2M2BN | c2M2BN | t2PN | 4PN | t3PN | c3PN | 3PN/2M3BN |

| | | | | | | |
|---|---|---|---|---|---|---|
| 90 min | 84.5 | 1.3 | 0.3 | 0 | 13.0 | 0.15 |
| 180 min | 72.4 | 1.5 | 0.5 | 0 | 24.4 | 0.34 |

### Example 7 (Comparison)

### (0.4 mmol of Ni(0))

1 equivalent of Ni(COD)₂ was admixed with 3 equivalents of ligand 1 and 465 equivalents of 2M3BN, stirred at 25° C. for one hour and heated to 115° C. Samples were taken from the reaction mixture after 90 minutes and after 180 minutes and analyzed by gas chromatography (GC % by area). The following results were obtained:

| Time | 2M3BN | t2M2BN | c2M2BN | t2PN | 4PN | t3PN | c3PN | 3PN/2M3BN |
|---|---|---|---|---|---|---|---|---|
| 90 min | 70.55 | 2.37 | 3.27 | 0 | 0.15 | 18.43 | 1.48 | 0.28 |
| 180 min | 65.07 | 2.99 | 5.88 | 0 | 0.19 | 20.40 | 1.56 | 0.34 |

### Example 8 (According to the Present Invention)

### (0.33 mmol of Ni(0))

1 equivalent of Ni(COD)₂ was admixed with 3 equivalents of ligand 2 and 465 equivalents of 2M3BN, stirred at 25° C. for one hour and heated to 115° C. Samples were taken from the reaction mixture after 90 minutes and after 180 minutes and analyzed by gas chromatography (GC % by area). The following results were obtained:

| Time | 2M3BN | t2M2BN | c2M2BN | T2PN | 4PN | t3PN | c3PN | 3PN/2M3BN |
|---|---|---|---|---|---|---|---|---|
| 90 min | 3.80 | 1.23 | 4.88 | 0 | 1.70 | 76.26 | 5.79 | 22.02 |
| 180 min | 3.28 | 1.33 | 6.36 | 0 | 2.28 | 75.72 | 6.76 | 24.87 |

### Examplee 9-12

### Hydrocyanation of 3-pentenenitrile to form Adiponitrile

### Example 9

### (0.6 mmol of Ni(0))

1 equivalent of nickel(0)-(m-/p-tolyl phosphite) was admixed with 365 equivalents of 3PN, stirred at 25° C. for one hour and heated to 70° C. 1 equivalent of ZnCl₂ was added to this mixture and the mixture was stirred for a further 5 minutes. 94 equivalents of HCN/h*Ni in a stream of argon carrier gas were then introduced. Samples were taken from the reaction mixture after 30 minutes and after 60 minutes and analyzed by gas chromatography (GC percent by weight, internal standard: ethylbenzene). The following results were obtained:

| Time | MGN | ADN | ADN selectivity (%) |
|---|---|---|---|
| 30 min | 3.35 | 10.75 | 76.2 |
| 60 min | 6.87 | 26.39 | 79.3 |

### Example 10 (Comparison)

### (0.51 mmol of Ni(0))

1 equivalent of Ni(COD)₂ was admixed with 3 equivalents of ligand 1 and 365 equivalents of 3PN, stirred at 25° C. for one hour and heated to 70° C. 1 equivalent of ZnCl₂ was added to this mixture and the mixture was stirred for a further 5 minutes. 130 equivalents of HCN/h*Ni in a stream of argon carrier gas were then introduced. Samples were taken from the reaction mixture after 30 minutes and after 60 minutes and analyzed by gas chromatography (GC percent by weight, internal standard: ethylbenzene). The following results were obtained:

| Time | MGN | ADN | ADN selectivity (%) |
|---|---|---|---|
| 30 min | 5.71 | 16.22 | 74.0 |
| 60 min | 5.26 | 15.48 | 74.7 |

### Example 11 (According to the Present Invention)

### (0.47 mmol of Ni(0))

1 equivalent of Ni(COD)₂ was admixed with 3 equivalents of ligand 2 and 365 equivalents of 3PN, stirred at 25° C. for one hour and heated to 70° C. 1 equivalent of ZnCl₂ was added to this mixture and the mixture was stirred for a further 5 minutes. 142 equivalents of HCN/h*Ni in a stream of argon carrier gas were then introduced. Samples were taken from the reaction mixture after 30 minutes and after 60 minutes and analyzed by gas chromatography (GC percent by weight, internal standard: ethylbenzene). The following results were obtained:

| Time | MGN | ADN | ADN selectivity (%) |
|---|---|---|---|
| 30 min | 5.41 | 17.57 | 77.4 |
| 60 min | 5.02 | 17.28 | 77.5 |

### Example 12 (According to the Present Invention)

### (0.58 mmol of Ni(0))

1 equivalent of Ni(COD)₂ was admixed with 3 equivalents of ligand 3 and 365 equivalents of 3PN, stirred at 25° C. for one hour and heated to 70° C. 1 equivalent of ZnCl₂ was added to this mixture and the mixture was stirred for a further 5 minutes. 105 equivalents of HCN/h*Ni in a stream of argon carrier gas were then introduced. Samples were taken from the reaction mixture after 30 minutes and after 60 minutes and analyzed by gas chromatography (GC percent by weight, internal standard: ethylbenzene). The following results were obtained:

| Time | MGN | ADN | ADN selectivity (%) |
|---|---|---|---|
| 30 min | 3.91 | 15.38 | 79.7 |
| 60 min | 6.25 | 32.91 | 84.0 |

1. A phosphinite I of the formula 1, 2 or 3 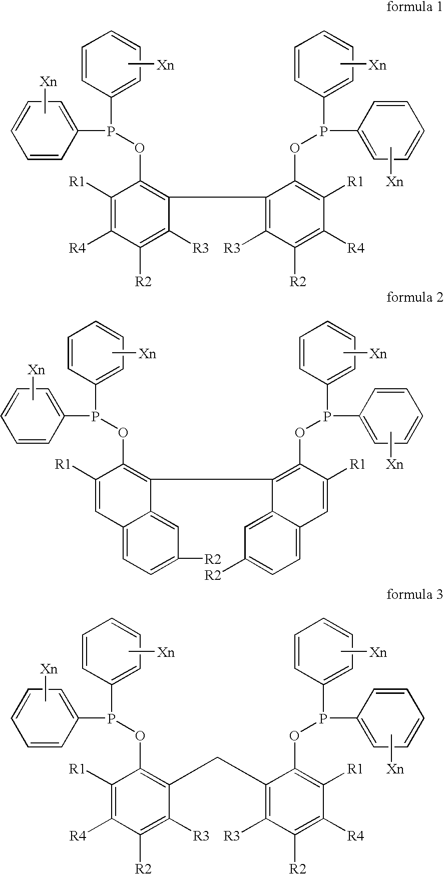
where
R1, R2, R4 are each, independently of one another, hydrogen, an alkyl or alkylene group having from 1 to 8 carbon atoms or an alkoxy group having from 1 to 8 carbon atoms, with the proviso that at least one of the groups R1, R2, R4 is not h,
R3 is h or methyl
x is f, Cl or CF₃
n is o, 1 or 2
or a mixture of such phosphinites,
with the proviso that
in formula 2, R¹ is not ethyl, R² is not hydrogen, x is not CF₃, and n is not 2 all at the same time, and
in formula 3, R¹ and R² are not tert-butyl, R³ and R⁴ are not hydrogen and n is not O all at the same time:

2. A phosphinite I as claimed in claim 1 in which R1, R2, R4 are selected independently from the group consisting of H, methyl, ethyl, n-propyl, i-propyl and t-butyl.

3. (canceled)

4. A transition metal complex comprising a phosphinite I as claimed in claim 1 as ligand.

5. A transition metal complex as claimed in claim 4, wherein the transition metal used is nickel,
with the proviso that
in formula 2 of phosphite 1, R1 and R² can be tert-butyl, R³ and R⁴ can be hydrogen and n can be O all at the same time.

6. A process for preparing transition metal complexes as claimed in claim 4, which comprises reacting an elemental transition metal or a chemical compound containing a transition metal with a phosphinite I.

7. A catalyst comprising the transition metal complex as claimed in claim 4.

8. (canceled)

9. (canceled)

10. A process for the addition of hydrocyanic acid onto an olefinic double bond in the presence of a transition metal complex as claimed in claim 4 as catalyst.

11. A process as claimed in claim 10, wherein hydrocyanic acid is added onto butadiene to give a compound selected from the group consisting of 2-methyl-3-butenenitrile and 3-pentenenitrile.

12. A process for the isomerization of organic nitrites in the presence of a transition metal complex as claimed in claim 4 as catalyst.

13. A process as claimed in claim 12, wherein 2-methyl-3-butenenitrile is isomerized to 3-pentenenitrile.

14. A process as claimed in claim 10, wherein hydrocyanic acid is added onto 3-pentenenitrile, 4-pentenenitrile or a mixture thereof to give adiponitrile.
